(19) United States
(12) Patent Application Publication
(10) Pub. No.: US 2015/0076235 A1
(43) Pub. Date: Mar. 19, 2015

(54) CHIPLESS NANOTUBE ELECTROMAGNETIC IDENTIFICATION SYSTEM FOR ANTI-COUNTERFEITING, AUTHORIZATION, AND BRAND PROTECTION

(71) Applicants: Zhengfang Qian, Kildeer, IL (US); You Liu, Danyang (CN)

(72) Inventors: Zhengfang Qian, Kildeer, IL (US); You Liu, Danyang (CN)

(21) Appl. No.: 14/025,883

(22) Filed: Sep. 13, 2013

(51) Int. Cl. G06K 19/067

(52) U.S. Cl. CPC G06K 19/0672
USPC 235/492

(57) ABSTRACT

Chipless RFID nanotube tags (300, 400, 500, 600, 700, 800, 900) with anti-counterfeiting capability are designed into one piece, mostly two pieces, three pieces, or multiple pieces of nanotube antenna elements on at least two dielectric substrates (310/312, 510/512, 810/812, 910/912/913/916 etc.) for providing brand product protection, authorization, anti-counterfeiting, and even recycling, and tag process control purposes.

### FIELD OF THE INVENTION

The present invention is related to a chipless nanotube RFID system for anti-counterfeiting, protection, and the authorization of such brand products as branded spirits, liquors, and wines, safety-critical items such as food, and life-threatening products such as medicines.

### BACKGROUND

High Valuable and branded products are facing serious counterfeiting issues, especially with the global supplier chain and economic growth. Huge losses are occurring daily for the companies who are making or selling the products. On the other hand, consumes are also the victims of faked high brand products. There are serious safety issues and sometime life threatening crimes due to faked medicines or toxic foods from counterfeiting products. Consumers, manufacturers, and governments all call for anti-counterfeit innovative solutions.

Prior arts provide conventional protective techniques and methods. U.S. Pat. No. 5,729,365 disclosed the optical holograms for authentication and tamper-protection. It is common to provide a printed label for anti-counterfeiting and authentication.

Radio Frequency Identification (RFID) has been widely used for automatic identification, asset tracking, and counterfeiting of brand products, etc. Most of these RFID tags or transponders include a chip for storing the item information and a radio antenna for wireless communication or data transmission between the reader or the interrogator and the tag. Prior art of such tags can be illustrated in FIG. 1, from typical patents, for instance, [1]. The cost of the chip is relatively high, comparing with traditional barcodes used billions each year. The tag cost with the chip limits its applications and the replacement of the barcode. The chipless tag is new category in the RFID family. The tag usually consists of multi-resonators. In order to accommodate sufficient bits for item unique information, these tags with multiple resonators made from metal elements such as copper strips are very large in size, comparing with the chipped tag. Specially, fully-passive chipless tag working in microwave frequency bands has typical size from tens of centimeters with only a few bits. It is not be satisfied for wide anti-counterfeiting applications where the assets or items are small in volume or area. Therefore, current chipless RFID tags found very limited applications due to their limited bits or/and large size.

Another deficient in current chipped RFID tag with antennas is the un-separable between the chip and antennas [2]. Once separated after manufacturing, the data inside the chip is not readable since the signal path from the chip to the antenna is broken. Although the feature can be used for anti-counterfeiting of the liquid bottle with a sealing cap in a destructive way [3, U.S. Pat. No. 7,176,796], the reuse or recycling of the original products become unpractical after the first use. There are also the quality and reliability programs for the customers to return products with any manufacturing defects, which requires the identification of original manufacturers and repair/replacement responsibilities. There are therefore needs for non-destructive protection and identification while providing the anti-counterfeiting function.

As a result, there is a strong demand and practical requirement for the antennas or resonators that can work at multiple frequencies, multiple locations, and much shorter radio frequency lengths. It is also desirable that the separable antenna elements. It is even more advantageous for providing nondestructive methods for anti-counterfeiting and product recycling. The huge consumer market calls for the chipless tags that are capable of anti-counterfeiting and data safety with small size for item-level RFID applications. Finally, it needs to be manufactured by low cost technologies.

### BRIEF SUMMARY OF THE INVENTION

Present invention provides unique solutions for anti-counterfeiting by using chipless nanotube patterns as the RFID tag. These nanotubes can be the resonator elements with different length and patterns when the RFID reader activates them in the right RF conditions. The sufficient bits can be achieved by the plurality of nanotube antennas or resonators with very small size in multiple antenna combinations and two-dimensional patterns or even one-dimensional patterns just like traditional bar codes. The radio frequencies of these nanotubes can reach millimeter wave range or tens to hundreds GHz frequency bands with each resonator element length from millimeters down to microns. Furthermore, the nanotube resonators can be fabricated by low-cost manufacturing methods such as printing technologies. The special fabrication substrate with the nanotube dispersion method is disclosed in the embodiments of another invention [4, Application No 61/698,657]. The chipless nanotube RFID tag is small, transparent, and even invisible, making extra safety for anti-counterfeiting purposes physically. Instead of destructive method for anti-counterfeiting, we disclose the recoverable anti-counterfeiting tag with at least two pieces of the antenna elements. One part is on or inside the bottle cap and another part is located on or inside the bottle body so that the two antenna elements must be the one combined ID enabled by the software that will be our another invention. We also provide three pieces and one tag ID solution for security protection combining both destructive and recoverable designs. Therefore, the multi-level purposes of anti-counterfeiting, authorization, brand protection, even recycling, and repairing/reworking are all served well by this invention.

### BRIEF DESCRIPTION OF THE DRAWINGS

The accompanying figures, where are incorporated in and form part of the specifications, serve to further illustrate various embodiments and to explain various principles and advantages all in accordance with the present invention. The foregoing aspects and the others will be readily appreciated by the skilled artisans from the following descriptions.

FIG. 1 illustrates a prior art of a typical RFID tag 100 with a semiconductor IC chip 112 as the digital information storage. At least one antenna with traditional metal elements 111 is necessary to receive the power from the reader and active the chip with the stored data. Another antenna or the same antenna can transmit the data back to the reader for identification. The carrier structure of the RFID tag is the substrate 113.

FIG. 2 is the prior art of typical anti-counterfeiting patent (e.g., U.S. Pat. No. 7,176,796 B2) where the sealing cap 212 serves as the antenna, therefore, must be metal. The chip 213 is connected by the connection wires 214 with the cap 212, the antenna. Once the cap is opened, the RFID tag is destroyed automatically in order to provide the anti-counterfeiting and protection. It is a destructive design for protection. The antenna (the cap) and the bottle 210 attached with the chip can not be separated for the tag identification.

FIG. 3 is our first embodiment example in which the two pieces of nanotube antennas 313 and 314 are combined to provide the unique RF identification with recycling and recoverable capabilities in addition to anti-counterfeiting.

FIG. 4 is another exemplary embodiment for the destructive method by using nanotube resonator elements 413 as the chipless tag 400.

FIG. 5 is yet another embodiment of this invention. The two dimensional nanotube antenna patterns are formed by combining the cap antenna part 513 and the bottle antenna resonators 514. It is the recoverable design with more bits available in a compact design.

FIG. 6 is yet another embodiment example of this patent. The random nanotube patterns 614 can be used as the second part of the tag antenna, combining with the first part 613 on or inside the cap 612 with more bits and safe identification.

FIG. 7 presents the most security method and design embodiment of this invention. Three pieces of the antenna elements can be combined to generate more than one RF IDs with more bits. It provides both destructive and recoverable solutions.

FIG. 8 is other example embodiment of this invention. The destructive protection method can be realized by the RF reader 815 after the verification and authorization processes.

FIG. 9 is yet the other embodiment of present invention for anti-counterfeiting medicines and drugs where the drug bottle has sufficient size and however the individual pills are very small. Only one or two or few nanotubes are necessary for the one pill or body surface.

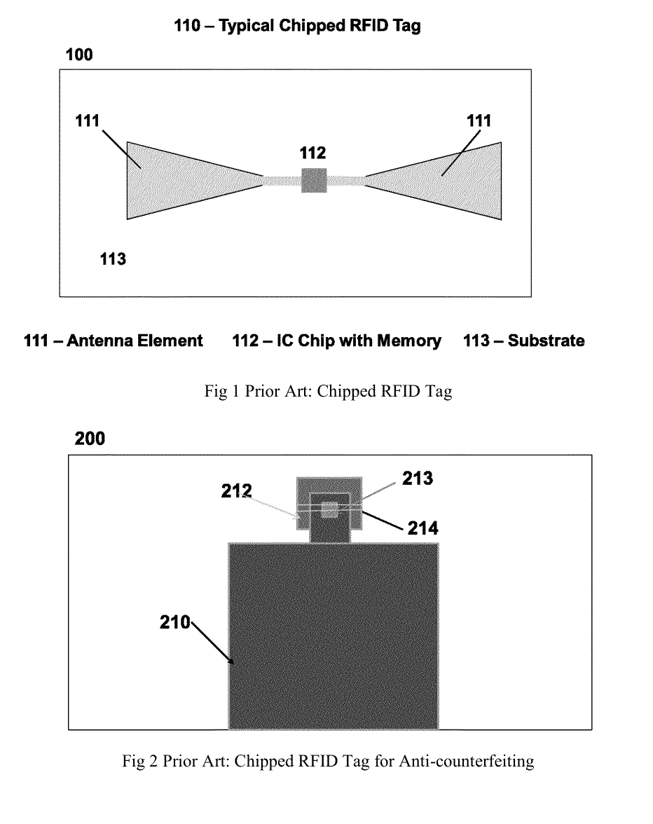

Skilled artisans will appreciate that elements or nanotubes in the figures are illustrated for simplicity and clarity and have not necessarily been drawn to actual scales. For instance, some of these nanotube elements in the figures may be exaggerated relatively to other elements to help to improve understanding of the embodiments of the present invention.

### DETAILED DESCRIPTION AND BEST MODE OF IMPLEMENTATION

### Definitions

For the purpose of the disclosure and embodiments, the term “nanotube” in this invention is meant to include any high aspect ratio linear or curved nano-scaled structures, including single-walled, double-walled, and multi-walled nanotubes, semiconducting or conductive nanotubes, nanowires, nanotube bundles, nanotube yarns, nanowires, and nano-columns, and nano-beams which can be used as resonators or can be made to vibrate in an electrical or/and electromagnetic fields. These preferably have a length from 1 micron, to 1 millimeter, and to tens of centimeters, depending on the radio frequencies and the tag size requirements. The diameters have a width or diameter from 0.2 nm to 1 micron, and to 1 millimeter. Examples of the present nanotubes also include such metallic as Ni, Cu, Ag, and Au nanowires. Preferred carbon nanotubes have metallic or conducting properties with one, two, or multi-walls and directional or anisotropic conductivity.

For the purpose of present invention, the term “electromagnetic signal” is used to mean either electromagnetic waves moving through air or dielectric or electrons moving through wires or both in any a frequency or a frequency range.

For present disclosure, the term “radio” is used to mean the wireless transmission or communication through electromagnetic waves in any a frequency or a frequency range from 1 MHz to 1 GHz, and to 1 THz. Preferred millimeter waves are frequencies from 30 GHz to 300 GHz.

For present disclosure, the term “tag” is used to mean a layer of nanotube patterns and a substrate with any shape of an oval, a square, a rectangle, a triangle, a circle, or polygons, and any size from 1 micron to 1 millimeter, and to tens of centimeters. It can also be multi-layers with different nanotube patterns and substrate materials.

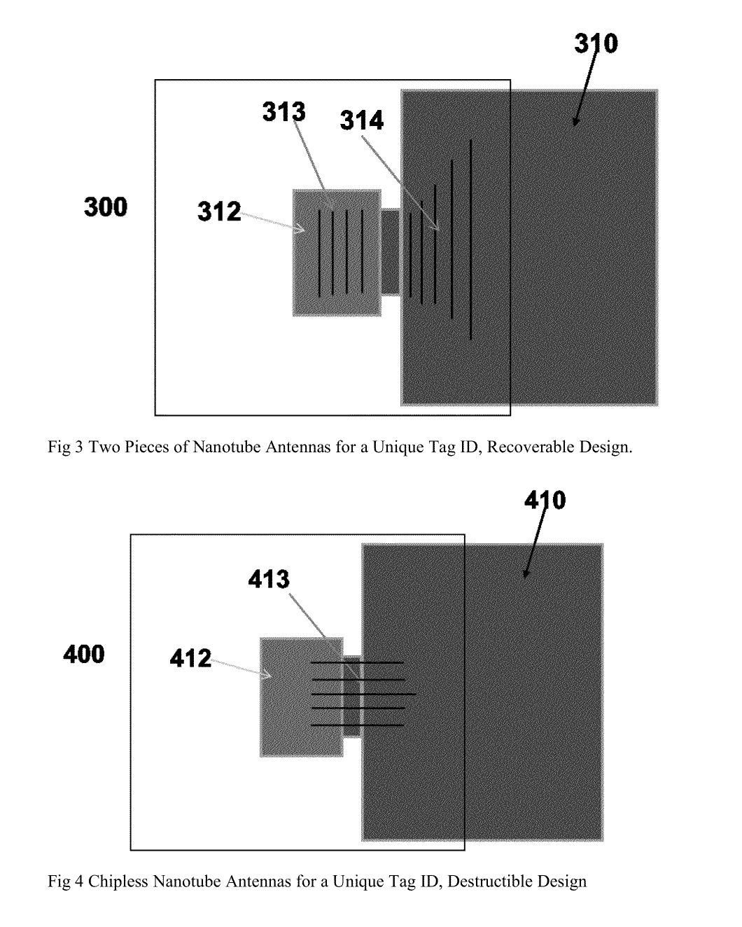

FIG. 3 is our first embodiment example in which the two pieces of nanotube antennas 313 and 314 are combined to provide the unique RF identification. The cap 312 and the bottle 310 can be separated. Once putting them together, the RF ID can be recovered. If one piece is faked either the cap 312 or the bottle 310, the RF identification can be detected and verified by the reader software.

FIG. 4 is another exemplary embodiment for the destructive method by using nanotube resonator elements 413 as the chipless tag 400. Once the cap 412 is opened, the tag antenna elements 413 will be destroyed naturally for the first-level brand protection.

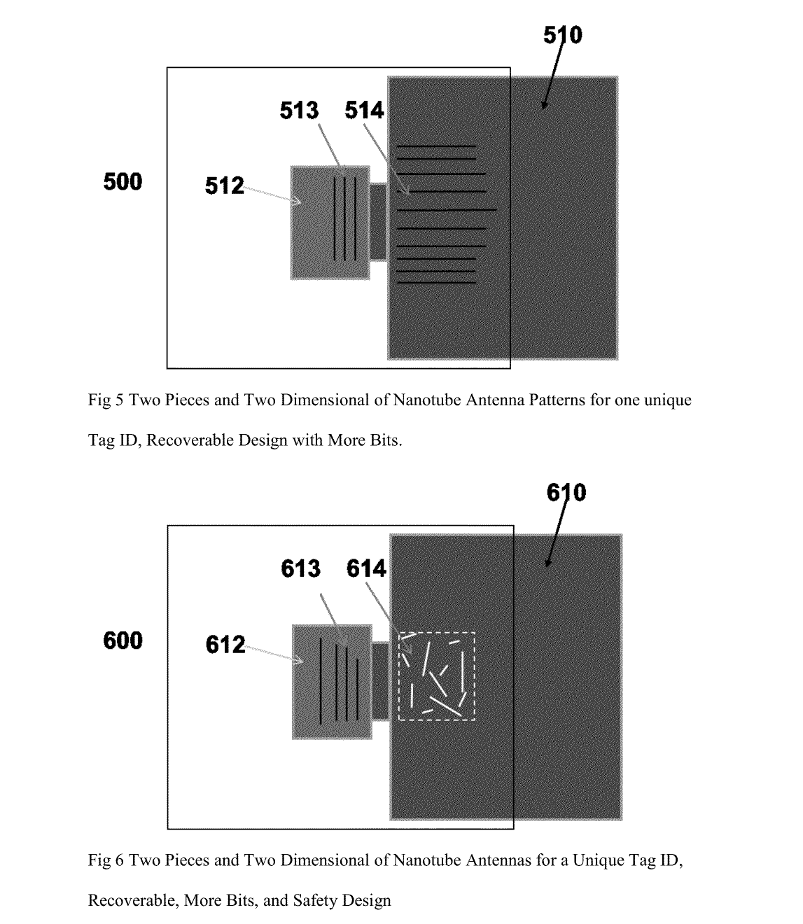

FIG. 5 is yet another embodiment of this invention. The two dimensional nanotube antenna patterns are formed by combining the cap antenna part 513 and the bottle antenna resonators 514. It is the recoverable design with more bits available in a compact design.

FIG. 6 is yet another embodiment example of this patent. The random nanotube patterns 614 can be used as the second part of the tag antenna, combining with the first part 613 on or inside the cap 612. More bits and safety ID can be realized by the reader software design.

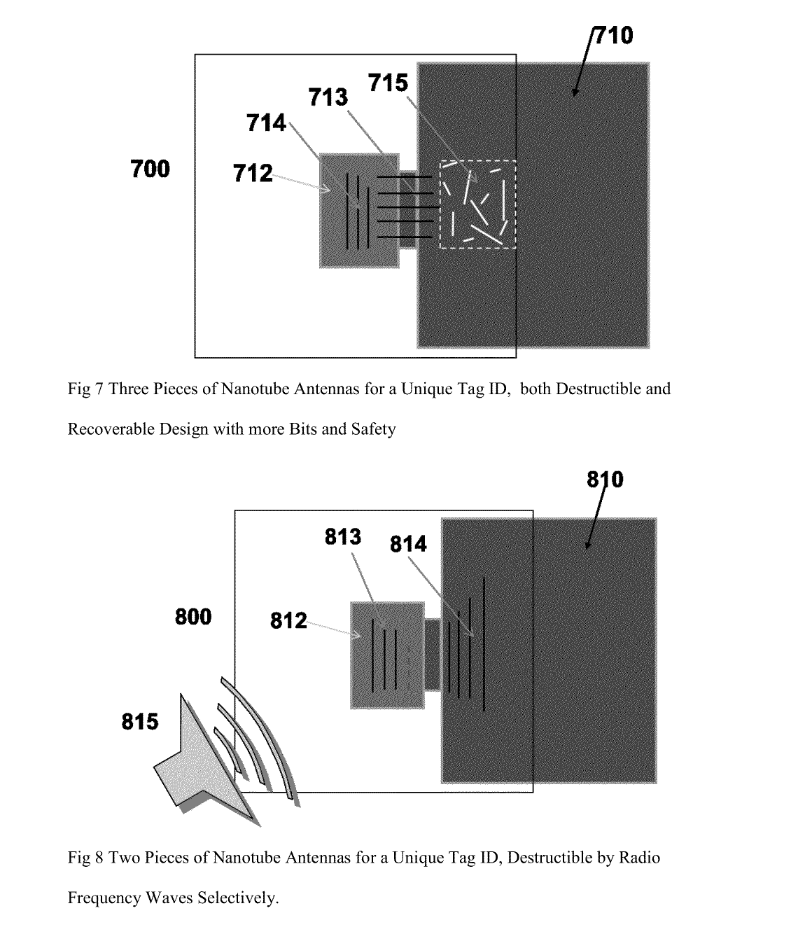

FIG. 7 presents the most security method and design embodiment of this invention. Three pieces of the antenna elements can be combined to generate more than one RF IDs with more bits. It provides both destructive and recoverable solutions. When the cap is opened, the first destructive protection is enabled by the antenna piece 713. However, if the antenna elements 714 and 715 are matched another ID in the system, the genuine product can be still identified for recycling or repairing, or reworking purposes. It can be used to recycle the bottle and the cap to further prevent faking of the brand products.

FIG. 8 is other example embodiment of this invention. The destructive protection method can be realized by the RF reader 815 after the verification and authorization processes. Certain nanotubes, e.g, presenting by the dash lines, can be destroyed by raising the radio frequencies power high enough in certain frequency selectively. The nanotube length will be determined and responded to the specific radio frequency from the reader. Therefore, after authorization and identification, the tag can be destroyed by randomly selecting the nanotubes for burning down. It prevents the bottles or containers from refilling faked liquids or wines. It is also an option for recycling if we reconfigure the tag by new data and store them for further identification. Therefore, it is protected or recycled by both hardware (nanotube antenna patterns) and software. It provides ultimate security, protection, and also options for recycling of cost saving. Moreover, the destructive actions can be even performed after the manufacturing of tags by the third party in order to provide the process control and safety. This makes our invention very unique so that the tags cannot be faked or copied by the third party or criminals.

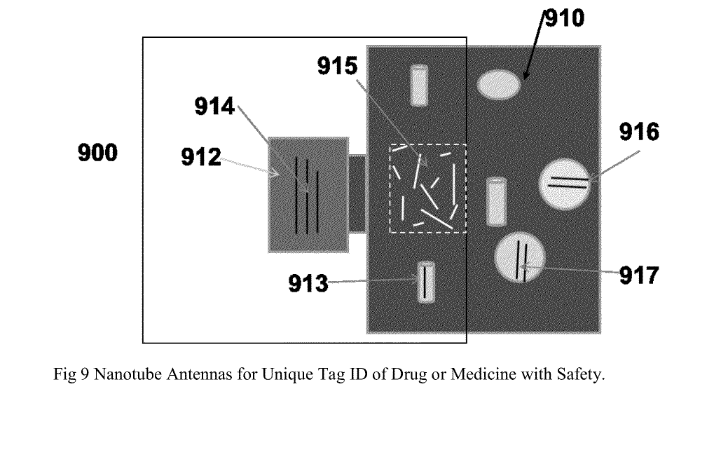

FIG. 9 is yet the other embodiment of present invention for anti-counterfeiting medicines and drugs where the drug bottle has sufficient size and however the individual pills are very small. Only one or two or few nanotubes are necessary for the one pill surface. Moreover, since we also provide protection from the nanotube antenna piece 914 for the cap, the 915 for the bottle, only few pills need the extra bites for combination and identification. It is also a cost-effective solution. This embodiment is also creative since we can combine the tag ID with different sizes of the antenna elements to meet the some critical needs such as a small pill or precious small parts.

### REFERENCES

[1] [1] U.S. Pat. No. 7,551,141, Hadley et al., RFID Strap Capacitively Coupled and Method of Making Same, Jun. 23, 2009.

[2] U.S. Pat. No. 6,891,474, Fletcher et al., Electromagnetic Identification Lable for Anti-counterfeiting, Authorization, and Tamper-Protection, May 10, 2005.

[3] U.S. Pat. No. 7,176,796, Chen et al., Anti-counterfeiting Sealing Cap with Identification Capability, Feb. 13, 2007.

[4] US Provident Patent Application No 61/698,657, Qian, Zhengfang, Nanotube Patterns for Chipless RFID Tags and Methods of Making the Same, Sep. 9, 2012.

[5] Zhengfang Qian, Patent Application: Coding and Decoding Methods of Nanotube Chipless RFID Tags.

What is claimed is:

1. a chipless tag of radio frequency identification capability for anti-counterfeit composing: various nanotube elements that can be any hollow conductors; wherein the length of elements is the order of the wavelength of RF radiation when transmitting a plurality of different frequencies; wherein each element as resonator from radiation, reflection or diffraction to produce a RF response in a form of radiation, reflection, or diffraction patterns which can be used for coding or/and decoding digital bits for identification with security, anti-counterfeiting, authorization, and brand protection; wherein the time-frequency signal patterns of phases and magnitudes of the resonators received by an reader device or receiver; the part of identification information coded from the signal patterns is from the first nanotube pattern structure on a substrate host that is the cap or the sealing part; another part of identification information coded from the signal patterns is from the second nanotube pattern structure on another substrate host that is the bottle or the container; other substrate host that is the object inside the bottle or the container for the third piece of the nanotube elements for identification or/and protection.

2. The structure of the nanotube elements according to claim 1 is distributed regularly in various one-dimensional patterns as embodiments.

3. The structure of the nanotube elements according to claim 1 is distributed randomly in various patterns as embodiments.

4. The structure of the nanotube elements according to claim 1 is distributed in two directions in an angle from zero to 180 degrees.

5. The structure of the nanotube elements according to claim 1 is stacked or overlapped in two directions in an angle from zero to 180 degrees to form various patterns.

6. The structure of the nanotube elements according to claim 1 is the combination of one directional regular pattern in the claim 2 in an angle with the structure randomly distributed according to the claim 3.

7. The structure of the nanotube elements according to claim 1 is any structural combination of above embodiments.

8. The material of host substrates according to claim 1 is plastic or dielectric, or ceramic, or metal, or composite.

9. The anti-counterfeit chipless RFID tag according to claim 1 is destroyed when any part of said nanotube piece is partially destroyed or separated; or up opening of said cap.

10. The anti-counterfeit chipless RFID tag according to claim 1 is destroyed when one or several nanotubes are selectively burned or broken by applied radio frequencies from a tag reader or transmitter after verification or/and authorization of the original manufacturing.

11. The anti-counterfeit chipless RFID information according to claim 1 is verified or authorized by the encapsulated codes from the first nanotube pattern, codes from the second nanotube pattern, and combined codes from both the first, second, and third pieces of the nanotube patterns.

12. The anti-counterfeit chipless RFID information according to claim 1 is used to verify the cap and the container from original manufacturing by the encapsulated codes from the first nanotube pattern, codes from the second nanotube pattern, or codes from third pieces of the nanotube patterns for recycling the original containers by the original manufacturer or preventing unauthorized use of the containers by the other parties.

13. The each nanotube element according to claim 1 is the resonator or the antenna element.

14. The anti-counterfeit chipless RFID information according to claim 1 is wirelessly received by the reader device or receiver and coded by specially developed software and algorithm from the time-frequency-phase signals from first nanotube resonator pattern, from the second nanotube resonator pattern, and any combination of the first, second, and third pieces of the nanotube resonator patterns.
